(19) United States
(12) Patent Application Publication
(10) Pub. No.: US 2002/0086723 A1
(43) Pub. Date: Jul. 4, 2002

(54) Discharge beater for a combine having an axial separator

(75) Inventors: Klaus Braunhardt, Zweibrucken (DE); Lutz Bischoff, Dellfeld (DE); Dirk Weichholdt, Sarreguemines (DE); Patrick J. Fisher, Kirkel-Alstadt (DE); Chad A. Dow, East Moline, IL (US)

Correspondence Address: Deere & Company, One John Deere Place, Moline, IL, 61265-8098, US

(73) Assignee: Deere & Company

(21) Appl. No.: 09/960,203

(22) Filed: Sep. 20, 2001

(30) Foreign Application Priority Data
Sep. 21, 2000 (DE) 100 47 464.0

(51) Int. Cl. A01F 12/39

(52) U.S. Cl. 460/113

(57) ABSTRACT

A combine having an axial separator that is provided with an outlet. A discharge beater is located adjacent the outlet. The discharge beater can be selectively rotated in response to crop throughput volume. The discharge beater is arranged to convey crop remains thrown out of the axial separator downwardly. The discharge beater is spaced away from the outlet of the axial separator in such a way that it comes into contact with the crop remains only when the axial separator is operating at relatively high throughput volumes.

### FIELD OF THE INVENTION

The invention is directed to a discharge beater for a combine having an axial separator. The discharge beater is arranged at the outlet of the axial separator and is rotated to convey crop remains ejected by the axial separator.

### BACKGROUND OF THE INVENTION

Combines of this type are known from WO 97/07660 A and DE 43 13 841 A. The discharge beater is used to convey the crop remains away from the axial separator and to eject them from the exhaust hood of the combine (in the case of swath deposit of the crop WO 97/07660 A) or to convey it to a straw chopper (DE 43 13 841 A).

One disadvantage is in the fact that the discharge beaters are arranged in the flow of the crop remains ejected from the axial separator. Discharge beaters obstruct the flow of the crop remains if they are not rotated. Therefore, the discharge beaters must be rotated continually, even if only a small amount of crop remains are conveyed.

### SUMMARY

It is an object of the present invention to provide a combine having an axial separator wherein an energy saving conveying arrangement for the crop remains is located on the outlet of the axial separator.

It is proposed that the discharge beater be arranged at a spacing from the outlet of the axial separator in such a way that it becomes effective only when the flow of the crop remains exceeds a certain threshold volume. As a result, it need not be driven continuously, rather it rotates as a free wheeling device at lower flow volumes of the crop remains, so that only a small amount of energy is needed to drive the discharge beater. The threshold volume may amount to, for example, 75% of the maximum possible flow of crop remains.

The axis of rotation of the discharge beater is preferably arranged approximately at the height of the underside of the axial separator and is attached behind the rear end of the axial separator as seen in the forward operating direction of the combine. As a rule, the side of the discharge beater facing the axial separator here rotates downward in order to conduct the crop remains to rearwardly and downwardly from the axial separator.

For the conveying of the crop remains the discharge beater is preferably provided with wings that contain a section extending radially that conveys the crop remains. At the outer end of the radial section, a section of the wings angled to the rear opposite to the direction of rotation can follow, which prevents crop remains from accumulating on the rear flank of the radial section.

The discharge beater may be driven continually. It is also conceivable that its drive be manually turned on and off, which can be controlled from an operator's cab. Its rotational speed can also be variable. A crop flow sensor can also be employed to turn the rotational drive of the discharge beater on and off or control its rotational speed.

### BRIEF DESCRIPTION OF THE DRAWINGS

FIG. 1 is a semi-schematic side view of a combine having a transversely arranged threshing assembly and an axially arranged separator that is provided with a discharge beater.

FIG. 2 is a side view of the discharge beater.

### DETAILED DESCRIPTION

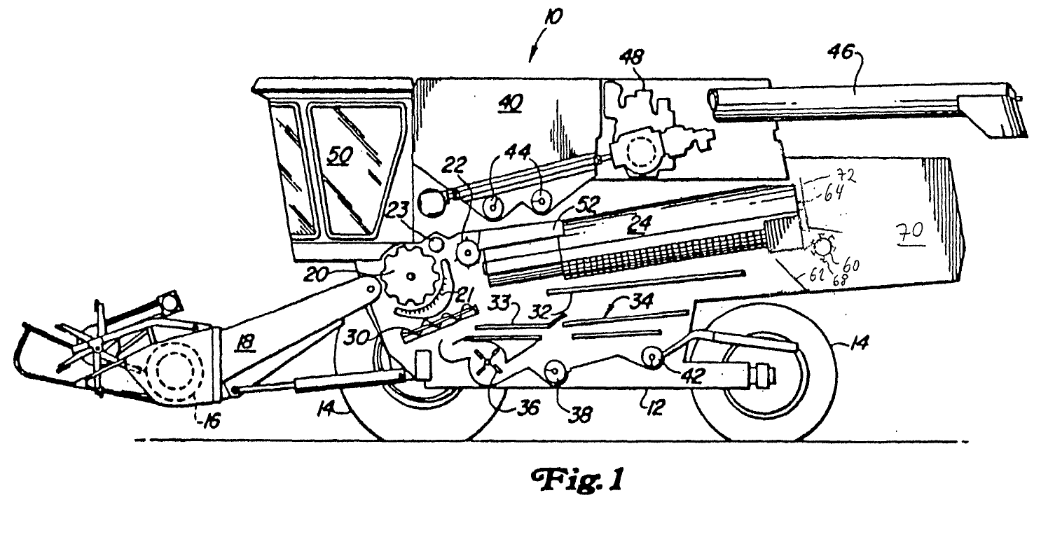

FIG. 1 shows a self-propelled combine 10 comprising a frame 12 that is supported and propelled by ground engaging wheels 14. To propel the combine 10, the wheels 14 are driven by a hydrostatic transmission powered by engine 48. The front of the combine 10 is provided with a harvesting assembly 16 that directs a harvested crop into a feeder house 18. The feeder house 18 in turn, directs the harvested crop upwardly and rearwardly into the combine and to the threshing assembly. The threshing assembly comprises a transverse threshing cylinder 20 and a transverse concave 21. The invention is illustrated as being used on a combine having a transversely arranged threshing assembly, however it could also be used on a combine having an axially arranged threshing assembly. From the threshing assembly the threshed crop is directed to a stripper roll 23 and a beater 22, from where it is directed to an axial separator 24. A single axial separator can be employed or a pair or more may be arranged alongside each other.

Grain and chaff that are separated during the threshing process, fall onto at least one screw conveyor 30, which conducts the grain and chaff to a grain pan 33. On the other hand, grain and chaff that originate in the axial separator 24, fall onto a shaker pan 32 that conducts it for further processing to the grain pan 33. The grain pan 33 passes the grain and the chaff along to a sieve 34 that is associated with a blower 36, in order to separate the chaff from the grain crop. Grain that has been cleaned is conducted by means of a clean grain auger 38 to an elevator, not shown, which conveys it into a grain tank 40. A transverse return auger 42 returns grain heads that were not threshed out back to the threshing process through another elevator, not shown. Finally, the cleaned grain is discharged from the grain tank 40 by a discharge system with transverse augers 44 and a discharge auger 46.

All the various aforementioned systems are driven by means of the internal combustion engine 48, which is operated by an operator from an operator's cab 50. The various arrangements for the threshing, conveying, cleaning and separating are located within the support frame 12.

In the illustrated embodiment, the threshing cylinder 20 and the concave 21 are equipped with pins as is provided for the threshing of rice; nevertheless this embodiment can be exchanged for a configuration that is employed for the threshing of other crops. The stripper roll 23 and the deflecting drum 22 together with a supply housing 52 conduct the threshed crop from the thresher assembly to the axial separator 24.

Threshed and separated crop remains (straw) are ejected from the axial separator 24 through a rear outlet 64 rearwardly from the axial separator. Due to the effect of gravity the crop remains fall onto a straw guide vane 62 and leave the combine 10 downward through an opening in the bottom of the exhaust hood 70 and are deposited as a swath on the field. In addition, crop remains ejected to the rear are guided downward by a rear wall 72 of the housing of the axial separator 24. The rear wall 72 is bent at an angle towards the rear in its lower region, located opposite the outlet 64.

In case the axial separator 24 does not have to cope with relatively large crop throughput, the crop remains fall out of the outlet 64 downward, if necessary guided by the rear wall 72, onto the straw guide vane 62 and from there to the ground. With relatively high crop throughput volumes, however, the crop remains can back up between the outlet 64 and the straw guide vane 62. Therefore, a discharge beater 60 with wings 68 is located in the discharge area behind the underside of the outlet 64 as seen in the forward operating direction. The wings 68 are distributed around the circumference of the discharge beater 60 and extend axially. The discharge beater axis is arranged approximately at the height of the underside of the axial separator 24. The discharge beater 60 can be driven to rotate in a counterclockwise direction as seen in FIG. 1. Therefore, the side of the discharge beater 60 facing the axial separator 24 rotates downwardly. The discharge beater 60 is used to assure that the crop remains are conveyed downwardly along the straw guide vane 62. The discharge beater 60 is arranged above and behind the flow of the crop remains in the direction of operation, in such a way that it comes into contact with the crop remains only if relatively high throughput volumes are to be handled. It can be driven continuously or only in the case of necessity (during high volumes of throughput), where it is put into operation by an operator in the operator's cab 50 or by a corresponding sensor.

It should be noted that the straw guide vane 62 can be arranged in a manner where it can be pivoted about a horizontal axis arranged at its lower end, extending transverse to the direction of operation, so that it can be pivoted between the swath depositing position shown in FIG. 1 and a chopper position, in which it is pivoted to the rear. In the chopper position the crop remains are conducted to a straw chopper, cut into small pieces there and distributed onto the ground.

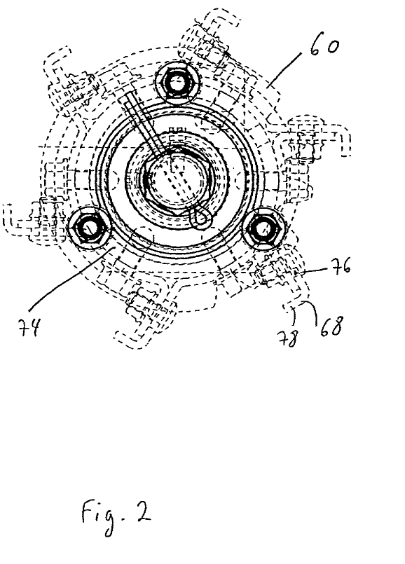

FIG. 2 shows the discharge beater 60 in greater detail. It comprises a central tube 74, about whose circumference six wings 68 are distributed. The wings 68 are provided with a section 76 extending approximately radially outward from the tube 74 and an outer section 78 angled to the rear opposite to the direction of rotation. Each of two adjacent wings 68 are fastened to each other by screws extending tangentially to the tube 74 that extend through the radial sections 76, and locked by other screws to the tube 74. The outer sections 78 that are angled to the rear prevent undesirable accumulations of material on the trailing rear side of the wings 68.

Having described the preferred embodiment, it will become apparent that various modifications can be made without departing from the scope of the invention as defined in the accompanying claims.

1. A combine having an axial separator, the axial separator having an outlet, a discharge beater that can be driven to rotate and is located adjacent to the outlet of the axial separator which is arranged to convey crop remains ejected by the axial separator, characterized by the discharge beater being spaced from the outlet of the axial separator in such a way that it comes into contact with the crop remains only if the flow of the crop remains is greater than a threshold volume.

2. A combine as defined by claim 1 wherein the axial separator is provided with an underside and the axis of rotation of the discharge beater is arranged approximately at the height of the underside of the axial separator.

3. A combine as defined by claim 2 wherein the axis of rotation of the discharge beater is arranged behind the axial separator as seen in the direction of operation.

4. A combine as defined by claim 3 wherein the discharge beater is provided with a side facing the outlet of the axial separator and that side of the discharge beater rotates downwardly.

5. A combine as defined by claim 4 wherein the discharge beater is provided with wings, which contain a section extending approximately radially outward and an outer section angled to the rear opposite to the direction of rotation.

6. A combine as defined by claim 5 wherein the discharge beater can be selectively rotated.

7. A combine as defined by claim 1 wherein the axis of rotation of the discharge beater is arranged behind the axial separator as seen in the direction of operation.

8. A combine as defined by claim 7 wherein the discharge beater is provided with a side facing the outlet of the axial separator, and that side of the discharge beater rotates downwardly.

9. A combine as defined by claim 8 wherein the discharge beater is provided with wings, which contain a section extending approximately radially outward and an outer section angled to the rear opposite to the direction of rotation.

10. A combine as defined by claim 9 wherein the discharge beater can be selectively rotated.

11. A combine as defined by claim 1 wherein the discharge beater is provided with a side facing the outlet of the axial separator and that side of the discharge beater rotates downwardly.

12. A combine as defined by claim 11 wherein the discharge beater is provided with wings, which contain a section extending approximately radially outward and an outer section angled to the rear opposite to the direction of rotation.

13. A combine as defined by claim 12 wherein the discharge beater can be selectively rotated.

14. A combine as defined by claim 1 wherein the discharge beater is provided with a side facing the outlet of the axial separator and that side of the discharge beater rotates downwardly.

15. A combine as defined by claim 14 wherein the discharge beater is provided with wings, which contain a section extending approximately radially outward and an outer section angled to the rear opposite to the direction of rotation.

16. A combine as defined by claim 15 wherein the discharge beater can be selectively rotated.

17. A combine as defined by claim 1 wherein the discharge beater can be selectively rotated.
